(19) United States
(12) Patent Application Publication
(10) Pub. No.: US 2018/0225955 A1
(43) Pub. Date: Aug. 9, 2018

(54) MOBILE ELECTRONIC DEVICE

(71) Applicant: KYOCERA Corporation, Kyoto (JP)

(72) Inventors: Tomohiro Degawa, Tokyo (JP); Keisuke Okada, Yokohama-shi (JP); Kentaro Aoki, Yokohama-shi (JP); Susumu Ozawa, Ebina-shi (JP); Jun Matsuzawa, Kawasaki-shi (JP)

(73) Assignee: KYOCERA Corporation, Kyoto (JP)

(21) Appl. No.: 15/885,862

(22) Filed: Feb. 1, 2018

(30) Foreign Application Priority Data
Feb. 8, 2017 (JP) 2017-021600

(51) Int. Cl. G08B 25/01; G08B 3/10

(52) U.S. Cl. CPC G08B 25/016; G08B 3/10

(57) ABSTRACT

A mobile electronic device that more effectively ensures the safety of the user is provided. A mobile electronic device includes a communication interface configured to transmit a signal, a sound output interface configured to output a sound, an operation detector configured to detect a user operation, and a controller configured to perform a first operation or a second operation when a predetermined operation is detected by the operation detector. In the first operation, the controller causes the sound output interface to output a predetermined alert sound and causes the communication interface to transmit a predetermined alert signal. In the second operation, the controller does not cause the sound output interface to output the predetermined alert sound and causes the communication interface to transmit the predetermined alert signal.

### CROSS-REFERENCE TO RELATED APPLICATION

The present application claims priority to and the benefit of Japanese Patent Application No. 2017-021600 filed Feb. 8, 2017, the entire contents of which are incorporated herein by reference.

### TECHNICAL FIELD

The present disclosure relates to a mobile electronic device.

### BACKGROUND

Mobile electronic devices configured to output an alert sound such as a buzzer in an emergency for the purpose of crime prevention are conventionally known.

### SUMMARY

A mobile electronic device according to the present disclosure includes a communication interface configured to transmit a signal, a sound output interface configured to output a sound, one or more operation detectors configured to detect a user operation, and a controller configured to selectively perform a first operation or a second operation when a predetermined operation is detected by the one or more operation detectors. In the first operation, the controller causes the sound output interface to output a predetermined alert sound and causes the communication interface to transmit a predetermined alert signal. In the second operation, the controller does not cause the sound output interface to output the alert sound and causes the communication interface to transmit the predetermined alert signal.

### BRIEF DESCRIPTION OF THE DRAWINGS

In the accompanying drawings:

FIG. 1 is an external view of a smartphone according to a first embodiment.

FIG. 2 is a functional block diagram illustrating the smartphone illustrated in FIG. 1.

FIG. 3A and FIG. 3B are diagrams each illustrating an example of a setting screen displayed on a touchscreen display illustrated in FIG. 1.

FIG. 4 is a flowchart illustrating operation of the smartphone according to the first embodiment.

FIG. 5 is a flowchart illustrating operation of the smartphone according to a second embodiment.

FIG. 6 is a flowchart illustrating operation of the smartphone according to a third embodiment.

FIG. 7 is a flowchart illustrating operation of the smartphone according to a fourth embodiment.

FIG. 8 is an external view of a smartphone according to a fifth embodiment.

FIG. 9 is a flowchart illustrating operation of the smartphone according to the fifth embodiment.

### DETAILED DESCRIPTION

The mobile electronic device described above may activate a security buzzer in response to the user operation. However, a mobile electronic device which, in an emergency situation for the user, is capable of appropriately outputting an alert sound on its own in accordance with its conditions, would further contribute to the safety of the user.

The present disclosure aims to provide a mobile electronic device capable of contributing to the safety of the user.

An embodiment of the present disclosure can contribute to the safety of the user.

### First Embodiment

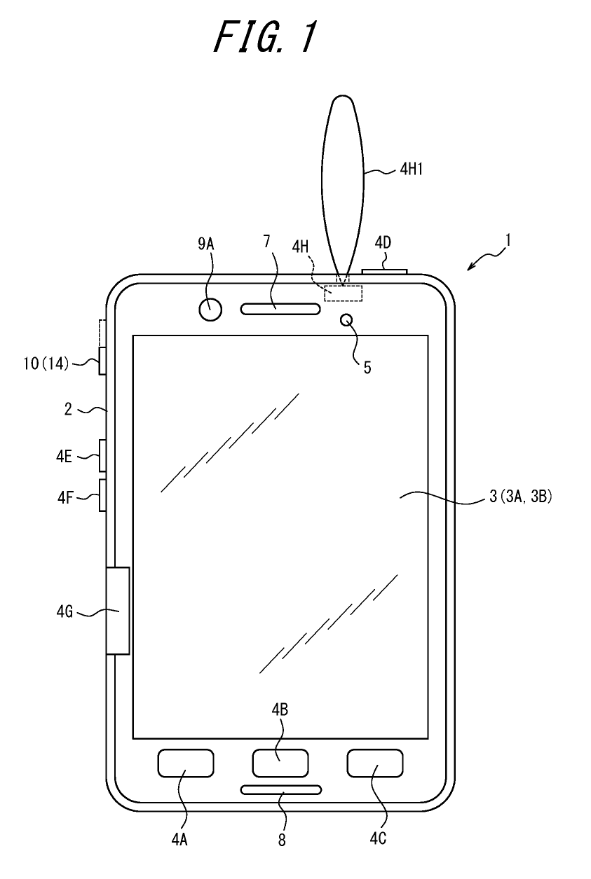

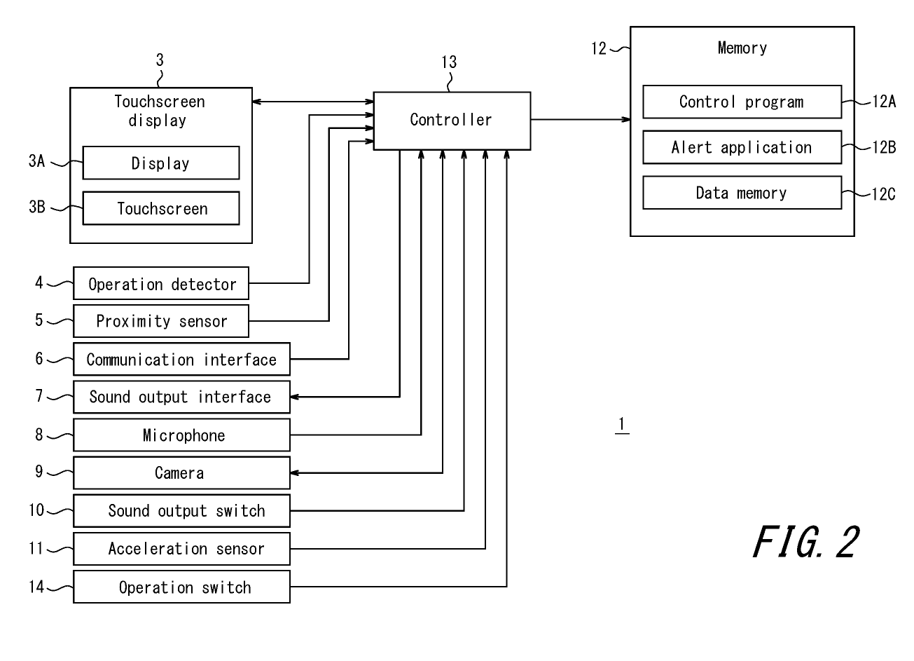

First, a configuration of a mobile electronic device according to a first embodiment will be described with reference to FIG. 1 and FIG. 2. FIG. 1 is an external view of the mobile electronic device according to the present embodiment. FIG. 2 is a functional block diagram illustrating the mobile electronic device illustrated in FIG. 1.

As illustrated in FIG. 1, the mobile electronic device 1 according to the first embodiment is a smartphone (hereinafter, referred to as a “smartphone 1”) and includes a housing 2, a touchscreen display 3, operation detectors 4A to 4H, a proximity sensor 5, a sound output interface 7, a microphone 8, a camera 9, and a sound output switch 10. As illustrated in FIG. 1, the touchscreen display 3, the operation detectors 4A to 4C, the proximity sensor 5, the sound output interface 7, the microphone 8, and the camera 9 are arranged on a front side of the housing 2 in FIG. 1. Also, the operation detectors 4D to 4H and the sound output switch 10 are arranged on lateral sides of the housing 2 in FIG. 1. Hereinafter, the operation detectors 4A to 4H may be collectively referred to as an operation detector 4 rather than specified individually.

The smartphone 1 according to the present embodiment also includes, in addition to the functional elements illustrated in FIG. 1, a communication interface 6, an acceleration sensor 11, a memory 12, and a controller 13, as illustrated in FIG. 2. These functional elements are accommodated in the housing 2 illustrated in FIG. 1.

As illustrated in FIG. 2, the controller 13 may be configured with, for example, a CPU (Central Processing Unit). The controller 13 may be an integrated circuit such as SoC (System-on-a-chip) in which other functional elements such as the communication interface 6 are integrated. The controller 13 may be configured as a combination of a plurality of integrated circuits. The controller 13 controls each functional element of the smartphone 1 and implements various functions by centrally controlling operation of the smartphone 1. Operation of the controller 13 according to the present embodiment will be described in detail later.

The touchscreen display 3 includes a display 3A and a touchscreen 3B. The display 3A includes a display such as an LCD (Liquid Crystal Display), an organic EL panel (Organic Electro-Luminescence panel), or an inorganic EL panel (Inorganic

Electro-Luminescence panel). The display 3A displays characters, images, symbols, shapes, and so on. The display 3A receives data necessary for its display from the controller 13. The display 3A may appropriately include a backlight and so on.

The touchscreen 3B detects contact made by a user's finger or a stylus pen that is operating the touchscreen display 3. The touchscreen 3B may detect positions of contact made by a plurality of fingers or stylus pens on the touchscreen 3B. For this detection, the touchscreen 3B may employ any method including a capacitive method, a resistive film method, a surface acoustic wave method (or an ultrasound method), an infrared method, an electromagnetic induction method, and a load detection method. A signal detected by the touch screen 3B is transmitted to the controller 13.

As described above, the touchscreen display 3 includes the display 3A and the touchscreen 3B. The display 3A displays objects such as the characters, images, symbols, and shapes. The touchscreen 3B detects an operation in respect of the smartphone 1 by detecting contact to the object serving as an operation target. The controller 13 cooperates with the touchscreen 3B and thus detects the operation to the touchscreen 3B (the touchscreen display 3).

The operation detector 4 detects a user operation. The operation detector 4 may output a detection signal upon detection of the user operation. The signal detected by the operation detector 4 is transmitted to the controller 13. The operation in respect of the operation detector 4 may include, for example, single-click, double-click, press, long-press, multiple-press.

For example, the operation detectors 4A to 4C may be a home-button, a back-button, and a menu-button. According to the present embodiment, the operation detectors 4A to 4C are touchsensor buttons. For example, the operation detector 4D is a button for powering on and off the smartphone 1. The operation detector 4D may also serve as a sleep/sleep-cancel button. For example, the operation detectors 4E and 4F may be volume control buttons.

The operation detector 4G is a button for controlling output of an alert sound from the sound output interface 7 and transmission of the alert signal. The alert sound may be, for example, a buzzer sound that can be heard by nearby people and inform them of the occurrence of a dangerous situation. The alert signal may be a message which notifies the occurrence of an emergency or a signal indicating an identifier. The alert signal may be transmitted to a security company contracted in advance, or a pre-registered destination such as a family member.

The smartphone 1 may include an operation detector 4H in place of the operation detector 4G The operation detector 4H detects a pulling operation performed by the user via a strap 4H1 connected to the operator detector 4H. The operation detector 4 may include both the operation detectors 4G and 4H.

The proximity sensor 5 detects a nearby object in a contactless manner. The proximity sensor 5 detects that, for example, the user of the smartphone 1 has moved the touchscreen display 3 close to the ear of the user to have a telephone conversation. The proximity sensor may output a detection signal when, for example, a predetermined object approaches the proximity sensor 5 within a predetermined distance. Also, the proximity sensor 5 may output, for example, a detection signal corresponding to a distance between the proximity sensor 5 and the predetermined object. The signal detected by the proximity sensor 5 is transmitted to the controller 13.

The communication interface 6 transmits and receives signals The communication interface 6 employs a communication method in conformity with a wireless communication standard. Examples of appropriate wireless communication standards are 2G (2nd Generation), 3G (3rd Generation), and 4G (4th Generation), for example Further examples of appropriate wireless communication standards are LTE (Long Term Evolution), W-CDMA, CDMA2000, PDC, GSM® (GSM is a registered trademark in Japan, other countries, or both), and PHS (Personal Handy-phone System). Further, wireless communication standards such as WiFi (The standard for Wireless Fidelity), WiMAX (Worldwide Interoperability for Microwave Access), IEEE802.11, Bluetooth® (Bluetooth is a registered trademark in Japan, other countries, or both), IrDA (Infrared Data Association), and NFC (Near field radio communication) may be used. The communication interface 6 may support one or more of the communication standards mentioned above.

The communication interface 6 may perform a call function to transmit a voice signal to another telephone device and receive a voice signal transmitted from the another telephone device on the basis of the control by the controller 13.

The sound output interface 7 outputs the sound signal output from the controller 13 as a voice. The sound output interface 7 is a speaker, for example. The sound output interface 7 is not limited to the speaker and may be any unit configured to output a sound that can be heard in the vicinity of the smartphone 1, e.g., within a range of a few meters.

The microphone 8 converts a voice of the user into a sound signal. The sound signal converted by the microphone 8 is transmitted to the controller 13. When the smartphone 1 performs the call function, the voice of the user of the smartphone 1 may be input to the microphone 8.

The camera 9 captures an image in front of the housing 2 illustrated in FIG. 1. The camera 9 may be arranged on a rear side of the housing 2 opposite to the front side illustrated in FIG. 1 to capture an image behind the housing 2. The camera 9 may transmit a captured image to the controller 13.

The sound output switch 10 is a switch whose position (i.e. state) is changed by a user operation to turn on/off a sound output. The controller 13 detects a position of the sound output switch 10 and, on the basis of the position, causes or does not cause the sound output interface 7 to output a sound. For example, the controller 13 causes the sound output interface 7 to output a sound when the sound output switch 10 is in an

ON-position. On the other hand, the controller 13 does not cause the sound output interface 7 to output a sound when the sound output switch 10 is in an OFF-position. An operation mode to not cause the sound output interface 7 to output a sound in a standby state of the smartphone 1 may correspond to the so-called manner mode or silent mode.

The acceleration sensor 11 measures acceleration of the smartphone 1. Data indicating the acceleration measured by the acceleration sensor 11 is transmitted to the controller 13.

The memory 12 stores programs and data. The memory 12 is also used as a working region to provisionally store the results of processing performed by the controller 13. The memory 12 may include any storage device such as a semiconductor storage device or a magnetic storage device. The memory 12 may include a plurality of different types of the storage devices. The memory 12 may include a combination of a portable storage media such as a memory card and a storage medium reader.

As illustrated in FIG. 2, the memory 12 stores, for example, a control program 12A and an alert application 12B. The control program 12A and the alert application 12B may be installed in the memory 12 via the wireless communication performed by the communication interface 6 or via the storage medium. An application program is abbreviated as “application” hereinafter.

The control program 12A is a program which causes the smartphone 1 to perform various functions. In particular, the controller 13 performs various functions under the control program 12A by, for example, controlling the functional elements of the smartphone 1.

The alert application 12B is, for example, an application which causes the display 3A to display a predetermined screen and perform processing according to operation detected via the touchscreen 3B. In particular, the alert application 12B is application for controlling the sound output by the sound output interface 7 and for causing the communication interface 6 to transmit a predetermined alert signal in response to, for example, an operation performed by a user to issue an alert.

The memory 12 includes a data memory 12C configured to store predetermined data acquired by the communication interface 6, the microphone 8, and the acceleration sensor 11. The predetermined data may be, for example, a voice detected by the microphone 8, temporal variations of the acceleration detected by the acceleration sensor 11, and surrounding data acquired by the communication interface 6 and indicating presence or absence of a nearby person.

Although the mobile electronic device 1 is described as the smartphone 1 above, the mobile electronic device 1 is not limited thereto. The mobile electronic device 1 may be a feature phone or a phablet. The mobile electronic device 1 may be a specialized terminal (for crime prevention) configured to output an alert sound and transmit an alert signal. In this case, the communication interface 6 does not need to include the call function described above.

Here, operation of the controller 13 performed in accordance with the alert application 12B during execution of the call function will be described.

In response to a user operation, the controller 13 performs a first operation or a second operation. Here, in the first operation the controller 13 controls such that the predetermined alert sound is output and the predetermined alert signal is transmitted. In the second operation the controller 13 controls such that the predetermined alert sound is not output and the predetermined alert signal is transmitted.

A conventional security buzzer for generating an alert sound outputs the alert sound at a loud volume in response to a user operation. At this point, the security buzzer may transmit an alert signal to a predetermined destination. However, outputting the alert sound in a dangerous situation where another party is trying to harm the user could upset the other party and the situation may further deteriorate. In some dangerous situations, accordingly, transmitting the alert signal without outputting the alert sound is appropriate from the viewpoint of user safety. As such, the controller 13 according to the present embodiment selectively performs the first operation or the second operation depending on various situations, which will be described later.

The following is a detailed description of processing in which the controller 13 performs the first operation or the second operation.

The controller 13 starts the operation according to the present embodiment when a predetermined operation is detected by a predetermined one of the operation detectors 4A and 4H. Hereinafter, the predetermined one of the operation detectors 4A and 4H will be referred to as “operation detector 4X”. The predetermined operation may be operation in a predetermined manner (e.g., the long-press or press for a predetermined number of times) performed to the operation detector 4X.

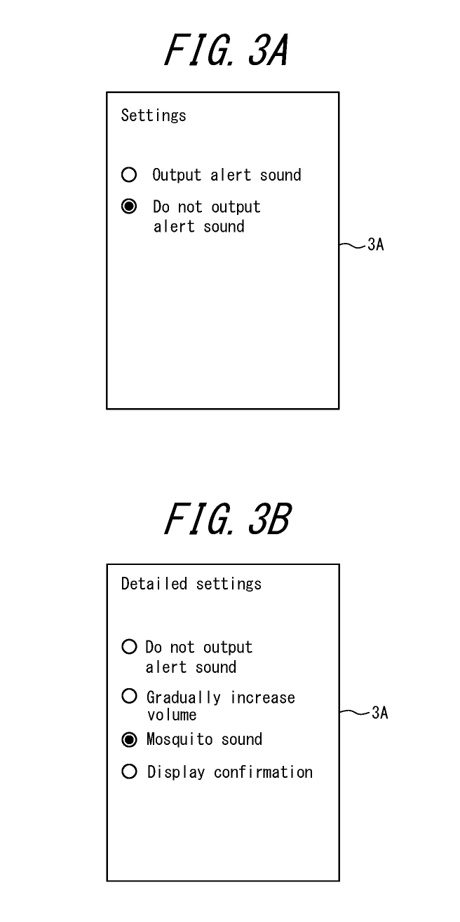

Prior to the start of the operation according to the present embodiment, the controller 13 sets the sound output of the sound output interface 7 in accordance with a user operation performed in advance. In particular, the controller 13, for example, displays a setting screen on the touchscreen display 3. The setting screen includes options as illustrated in FIG. 3A that allow the user to select the first operation or the second operation. For example, the setting screen includes options such as “Alert Sound” and “No Alert Sound” that allow selection of whether to output the alert sound. When detecting contact made to a radio button corresponding to a display region of the “Alert Sound” option on the touchscreen display 3, the controller 13 sets such that the first operation is performed in a situation where one of the first operation and the second operation should be performed. The first operation is the operation to cause the sound output interface 7 to output the predetermined alert sound and cause the communication interface 6 to transmit the predetermined alert signal. When detecting contact made to a radio button corresponding to a display region of the “No Alert Sound” option on the touchscreen display 3, the controller 13 sets such that the second operation is performed in a situation where one of the first operation and the second operation should be performed. The second operation is the operation to not cause the sound output interface 7 to output the predetermined alert sound and to cause the communication interface 6 to transmit the predetermined alert signal.

When detecting the contact made to the radio button corresponding to the display region of the “No Alert Sound” option in the touchscreen display 3, the controller 13 may cause the touchscreen display 3 to display a detailed setting screen. The detailed setting screen includes, for example, options that allow the user to select operation of the sound output interface 7 such as “Silent”, “Gradually Increase Volume”, “Mosquito Sound”, and “Confirm” as illustrated in FIG. 3B.

Upon detecting contact made to a radio button corresponding to a display region of the “Silent” option in the detailed setting screen, the controller 13 sets such that the sound output interface 7 does not output a sound in the subsequent second operation. Upon detecting contact made to a radio button corresponding to a display region of the “Gradually Increase Volume” option in the detailed setting screen, the controller 13 sets such that the sound output interface 7 output a sound gradually increasing the volume in the subsequent second operation. Upon detecting contact made to a radio button corresponding to a display region of the “Mosquito Sound” in the detailed setting screen, the controller 13 sets such that the sound output interface 7 outputs a mosquito sound in the subsequent second operation.

When detecting contact made to a radio button corresponding to a display region of the “Confirm” option in the detailed setting screen, the controller 13 sets such that the sound output interface 7 outputs the alert sound upon detection of operation to output the sound in the subsequent second operation. In particular, after causing the communication interface 6 to transmit the alert signal, the controller 13 causes the touchscreen display 3 to display a confirmation screen. The confirmation screen includes a question asking the user whether to output the alert sound and buttons to choose between “Output Sound” or “No Sound” for the alert sound from the sound output interface 7. When detecting contact made to the button corresponding to output of the alert sound, the controller 13 causes the sound output interface 7 to output the alert sound. When detecting contact made to the button corresponding to no output of the alert sound, the controller 13 does not cause the sound output interface 7 to output the alert sound.

The controller 13 may display a single setting screen that includes the options displayed in the setting screen and the markers displayed in the detailed setting screen, altogether.

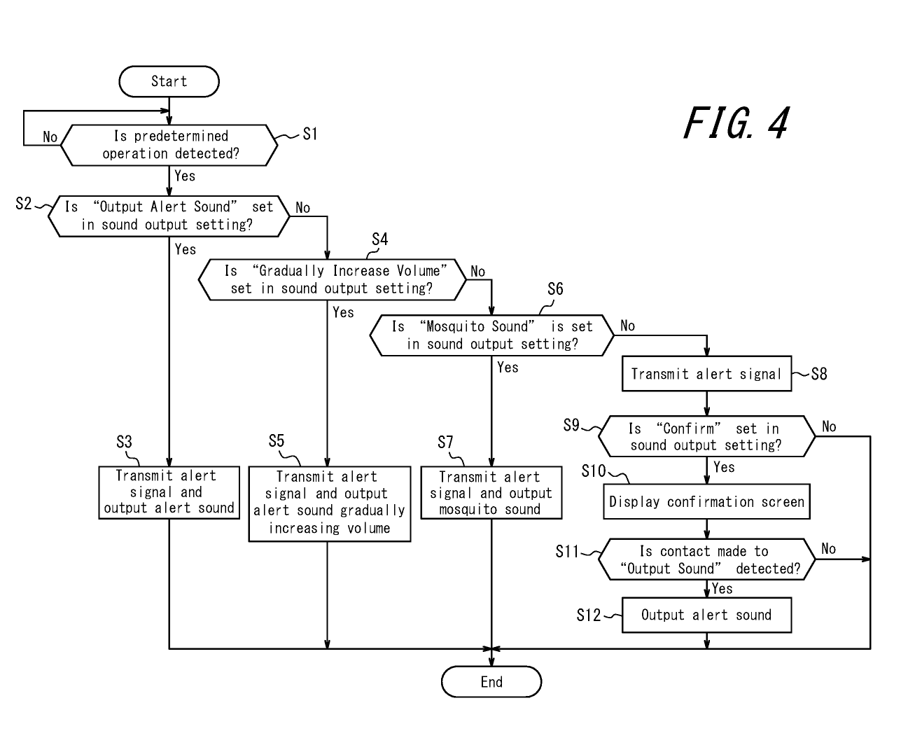

Here, operation of the smartphone 1 according to the first embodiment will be described with reference to FIG. 4. The controller 13 starts the operation illustrated in FIG. 4 when, for example, the smartphone 1 is activated.

First, the controller 13 determines whether a predetermined operation is detected by the operation detector 4 (step S1). The predetermined operation is, for example, the push-operation made to the operation detector 4G as described above. The predetermined operation may be displacement of the operation detector 4H caused by the pulling operation made to the strap 4H1.

When the predetermined operation is detected at step S1, the controller 13 determines whether the “Alert Sound” is selected in the sound output setting. When the predetermined operation is not detected at step S1, the controller 13 returns to step S1 and again determines whether the predetermined operation is detected by the operation detector 4.

When the “Alert Sound” option is selected in the sound output setting at step S2, the controller 13 causes the communication interface 6 to transmit the predetermined alert signal and causes the sound output interface 7 to output the predetermined alert sound (step S3).

When the “Alert Sound” option is not selected in the sound output setting at step S2, the controller 13 determines whether the “Gradually Increase Volume” option is selected in the sound output setting (step S4).

When the “Gradually Increase Volume” option is selected in the sound output setting at step S4, the controller 13 causes the communication interface 6 to transmit the predetermined alert signal and causes the sound output interface 7 to output the predetermined alert sound gradually increasing the volume (step S5).

When the “Gradually Increase Volume” option is not selected in the sound output setting at step S4, the controller 13 determines whether the “Mosquito Sound” option is selected in the sound output setting (step S6).

When the “Mosquito Sound” option is selected in the sound output setting at step S6, the controller 13 causes the communication interface 6 to transmit the predetermined alert signal and causes the sound output interface 7 to output the mosquito sound (step S7).

When the “Mosquito Sound” option is not selected in the sound output setting at step S6, the controller 13 causes the communication interface 6 to transmit the predetermined alert signal indicating the occurrence of an emergency to a security company contracted in advance or a pre-registered destination such as a family member (step S8).

When the predetermined alert signal is transmitted at step S8, the controller 13 determines whether the “Confirm” option is selected in the sound output setting (step S9).

When the “Confirm” option is selected in the sound output setting at step S9, the controller 13 causes the touchscreen display 3 to display the confirmation screen described above (step S10).

When the confirmation screen is displayed at step S9, the controller 13 determines whether contact made to the display region of the “Output Sound” option in the confirmation screen is detected (step S11).

When contact made to the display region of the “Output Sound” option is detected at step S11, the controller 13 causes the sound output interface 7 to output the predetermined alert sound (step S12).

When contact made to the display region of the “Output Sound” option is not detected at step S11, the controller 13 ends the operation illustrated in FIG. 4.

According to the first embodiment, as described above, the controller 13 selectively performs the first operation or the second operation when the user operation is detected. In the first operation, the controller 13 causes the sound output interface 7 to output the predetermined alert sound and causes the communication interface 6 to transmit the predetermined alert signal. In the second operation, the controller 13 does not cause the sound output interface 7 to output the predetermined alert sound and causes the communication interface 6 to transmit the predetermined alert signal. That is, upon detection of the predetermined operation, the smartphone 1 selectively outputs the alert sound depending on the situation. Therefore, when the user is in a dangerous situation, the smartphone 1 may reduce a risk that the dangerous situation deteriorates due to outputting the alert sound. For example, the controller 13 performs the second operation to control such that the predetermined alert sound is not output and thus is capable of avoiding upsetting a party who is trying to harm the user. On the other hand, when there is no risk of upsetting the party, the controller 13 performs the first operation to control such that the predetermined alert sound is output to seek help from a nearby third party. The sound output interface 7 configured to output the alert sound is controlled in this manner and thus contributes to the safety of the user.

Further, according to the first embodiment, in the first operation the controller 13 causes the sound output interface 7 to output the predetermined alert sound and causes the communication interface 6 to transmit the predetermined alert signal. In the second operation the controller 13 does not cause the sound output interface 7 to output the predetermined alert sound and causes the communication interface 6 to transmit the predetermined alert signal. Thus, in an emergency for the user of the smartphone 1, the controller 13 causes the alert signal to be transmitted while selectively causing the alert sound to be output. In some emergency situations, avoiding outputting the alert sound may be appropriate to prevent an increase in the risk for the user. Therefore, the alert signal indicating the occurrence of an emergency is transmitted to the security company or the family member, while the alert sound is selectively output depending on the situation. This configuration appropriately contributes to the safety of the user.

According to the first embodiment, also, the controller 13 allows selection between the first operation and the second operation on the setting screen. Thus, the user may select in advance whether to output the alert sound in an emergency. This configuration appropriately contributes to the safety of the user.

Further, according to the first embodiment, in the second operation the controller 13 may cause the sound output interface 7 to output a sound different from the predetermined alert sound (a typical alert sound). In some situations where it is appropriate to avoid outputting the predetermined alert sound in an emergency, outputting a different sound may contribute to the safety of the user.

Further, according to the first embodiment, the controller 13 may cause the sound output interface 7 to output the mosquito sound. For example, there may be a case where the person who is trying to harm the user is relatively old and cannot hear the mosquito sound, and a young person is likely to rescue the user from a dangerous situation. In this case, outputting the mosquito sound that is easily heard by young people may alert the young person who is likely to rescue the user without alerting the relatively old person. In this case, a person who notices the alert sound may rescue the user. Thus, this configuration contributes to the safety of the user.

According to the first embodiment, also, the controller 13 may cause the sound output interface 7 to output the sound with gradually increasing volume. Thus, in situations where is appropriate to avoid outputting the predetermined alert, outputting the sound with gradually increasing volume may contribute to the safety of the user.

Further, according to the first embodiment, in the second operation the controller 13 may cause the communication interface 6 to transmit the predetermined alert and then controls such that the predetermined alert sound is output in response to the user operation detected by the operation detector 4. Accordingly, in an emergency for the user, the controller 13 may promptly transmit the alert signal and control to selectively output the sound on the basis of a judgment made by the user according to the situation. This configuration may appropriately contribute to the user safety according to the situation.

### Second Embodiment

Next, a second embodiment of the present disclosure will be described with reference to the drawings. A functional block diagram according to the second embodiment is similar to that according to the first embodiment, and thus descriptions thereof will be omitted. Also, descriptions similar to those of the first embodiment will also be omitted.

According to the first embodiment, the controller 13 controls the sound output on the basis of the setting performed by contact made to the setting screen displayed in the touchscreen display 3. According to the second embodiment, the smartphone 1 includes an operation switch 14 that enables selection between the first operation and the second operation to be performed when the operation is detected by the operation detector 4. The sound output switch 10 may also serve as the operation switch 14. In this case, the smartphone 1 does not need to include both the sound output switch 10 and the operation switch 14; the smartphone 1 may include only one of them. Thus, the smartphone 1 may have a simplified configuration. Alternatively, the operation switch 14 may be a switch independent of the sound output switch 10.

The controller 13 controls the sound output by detecting a setting of the operation switch 14. The operation switch 14 is displaced along a side face by a user's switchover operation to select the first operation or the second operation. For example, when the sound output switch 10 is in a predetermined position (i.e. state) on the left side of the housing 2 as illustrated in FIG. 1, the first operation is set. When the sound output switch 10 is positioned in the dotted lines in FIG. 1 above the position for selecting the first operation, the second operation is set.

The controller 13 determines whether the first operation or the second operation is set by the sound output switch 10. When the first operation is set by the sound output switch 10, the controller 13 performs the first operation. When the second operation is set by the sound output switch 10, the controller 13 performs the second operation.

In the case in which the sound output switch 10 also serves as the operation switch 14 as described above, the controller 13 may perform the first operation when the sound output switch 10 is set to output the sound. In this case, also, the controller 13 may perform the second operation when the sound output switch 10 is set to not output the sound. Accordingly, when the sound output switch 10 is set to not output the sound, the sound is not output in an emergency. When the sound output switch 10 is set to output the sound, the sound is output in an emergency. As such, the user may set such that the sound output is reliably controlled in an emergency as intended by the user, which can be otherwise confusing.

When the sound output switch 10 is set to the second operation, the controller 13 may control, on the basis of the setting made in advance as with the first embodiment, such that the sound output interface 7 gradually increases the volume or outputs the mosquito sound, or such that the confirmation screen is displayed in the touchscreen display 3 and, upon detection of contact made to the display region of the “Output Sound” option, the alert sound is output.

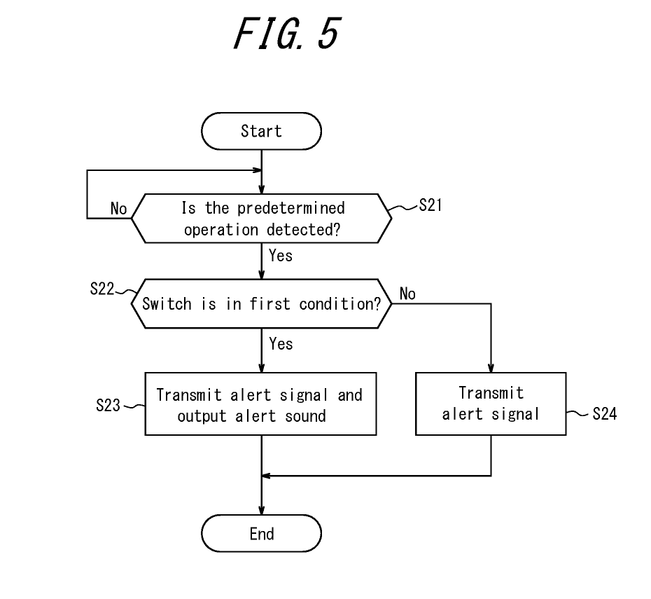

Here, operation of the smartphone 1 according to the second embodiment will be described with reference to FIG. 5. The controller 13 starts this operation when the smartphone 1 is activated.

First, the controller 13 determines whether a predetermined operation is detected by the operation detector 4 (step S21). As with the first embodiment, the predetermined operation is, for example, the push-operation made to the operation detector 4. The predetermined operation may be the displacement of the operation detector 4H caused by the pulling operation made to the strap 4H1.

Upon detection of the predetermined operation at step S21, the controller 13 determines whether the sound output switch 10 is set to the “first operation” (step S22). When the predetermined operation is not detected at step S21, the controller 13 returns to step S21 and again determines whether the predetermined operation is detected by the operation detector 4.

When the sound output switch 10 is set to the “first operation” at step S22, the controller 13 causes the communication interface 6 to transmit the predetermined alert signal and causes the sound output interface 7 to output the predetermined alert sound (step S23).

When the sound output switch 10 is not set to the “first operation”, i.e., set to the “second operation” at step S22, the controller 13 causes the communication interface 6 to transmit the predetermined alert signal (step S24). In this case, the controller 13 does not cause the sound output interface 7 to output the predetermined alert sound. When sound output switch 10 is set to the “second operation” at step S22, the controller 13 may perform procedures from step S4 to step S12 according to the first embodiment, on the basis of the sound output setting set in advance.

According to the second embodiment, as described above, the controller 13 selectively performs the first operation or the second operation in accordance with the setting of the operation switch 14. Thus, the user may perform a simplified operation to select whether to output the alert sound in an emergency.

### Third Embodiment

Next, a third embodiment of the present disclosure will be described with reference to the drawings. An external view and a functional block diagram according to the third embodiment are similar to those of the first embodiment, and thus descriptions thereof will be omitted. Also, descriptions similar to those of the first embodiment will also be omitted.

According to the first embodiment, the controller 13 controls the sound output on the basis of the setting performed by contact made to the setting screen displayed in the touchscreen display 3. According to the third embodiment, the controller 13 selectively performs the first operation or the second operation, on the basis of data of a detection target detected by the proximity sensor 5 and the touchscreen 3B constituting a contact sensor. According to the third embodiment, the touchscreen 3B detects contact by employing the capacitance method.

In particular, the controller 13 performs the first operation when a nearby object is detected by the proximity sensor 5. When a nearby object is not detected by the proximity sensor 5 and, simultaneously, contact made by a human body is detected by the touchscreen 3B serving as the contact sensor, the controller 13 performs the first operation. When a nearby object is not detected by the proximity sensor 5 and, simultaneously, contact made by a human body is not detected by the touchscreen 3B serving as the contact sensor, the controller 13 performs the second operation. The contact sensor employs the capacitance method, and the controller 13 detects contact made by a human body when an electric signal measured by the contact sensor has a pattern unique to contact made by a human body.

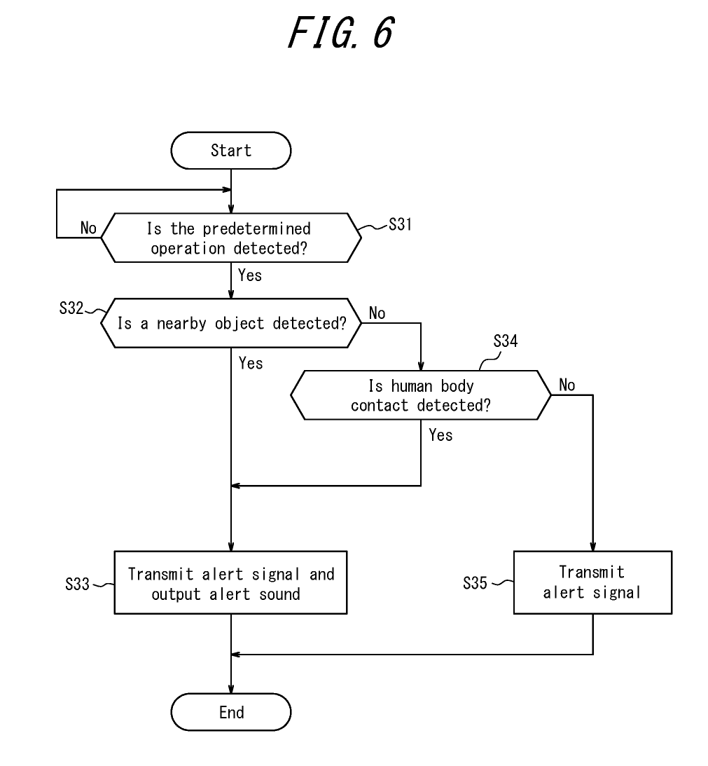

Here, operation of the smartphone 1 according to the third embodiment will be described with reference to FIG. 6. The controller 13 starts this operation when the smartphone 1 is activated.

First, the controller 13 determines whether a predetermined operation is detected by the operation detector 4 (step S31). As with the first embodiment, the predetermined operation is, for example, the push-operation made to the operation detector 4G The predetermined operation may be the displacement of the operation detector 4H caused by the pulling operation made to the strap 4H1.

When the predetermined operation is detected at step S31, the controller 13 determines whether a nearby object is detected by the proximity sensor 5 (step S32). When the predetermined operation is not detected at step S31, the controller 13 returns to step S31 and again determines whether the predetermined operation is detected by the operation detector 4.

When a nearby object is detected at step S32, the controller 13 causes the communication interface 6 to transmit the predetermined alert signal and the sound output interface 7 to output the predetermined alert sound (step S33).

When a nearby object is not detected at step S32, the controller 13 determines whether contact made by a human body is detected by the contact sensor (step S34).

When contact made by a human body is detected at step S34, the controller 13 causes the communication interface 6 to transmit the predetermined alert signal (step S35). When contact made by a human body is not detected at step S34, the controller 13 causes the communication interface 6 to transmit the predetermined alert signal and causes the sound output interface 7 to output the predetermined alert sound (step S33).

According to the third embodiment, as described above, when the operation is detected by the operation detector 4, the controller 13 selectively performs the first operation or the second operation on the basis of the data detected by the sensor such as the proximity sensor 5 and the contact sensor. On the basis of the detected data, whether the smartphone 1 is visible to a party who may harm the user may be inferred. For example, when the smartphone 1 is not visible to a party but outputs the alert sound, the party may notice that the user has a security apparatus on him/her, thus possibly leading to an unfavorable situation. In this case, when the smartphone 1 is positioned inside a pocket and receives a predetermined operation, it is often the case that the user desires that the predetermined alert sound not be output. When the user is directly touching the smartphone 1 with his/her hand, it is often the case that the user desires that the predetermined alert sound be output. Accordingly, when the controller performs control on the basis of the data detected by the sensor, the sound may be selectively output as desired by the user. This configuration appropriately contributes to the safety of the user.

### Fourth Embodiment

Next, a fourth embodiment of the present disclosure will be described with reference to the drawings. An external view and a functional block diagram according to the fourth embodiment are similar to those of the first embodiment, and thus descriptions thereof will be omitted. Also, descriptions similar to those of the first embodiment will also be omitted.

According to the third embodiment, as described above, the controller 13 controls the sound output on the basis of the detection of a nearby object by the proximity sensor 5 and detection of contact by the contact sensor. According to the fourth embodiment, the controller 13 controls the sound output on the basis of predetermined data acquired by the smartphone 1.

In particular, the controller 13 acquires, as the predetermined data, data indicating a voice acquired by the microphone 8 and stores the predetermined data in the data memory 12C of the memory 12. The controller 13 controls the sound output on the basis of the predetermined data stored in the memory 12. For example, when the voice corresponds to a predetermined pattern and the pulling operation is made by the user to the operation detector 4H, the controller 13 performs the first operation. When the voice does not correspond to the predetermined pattern, the controller 13 performs the second operation in a situation where the first operation or the second operation should be performed.

The predetermined pattern for the voice is a voice pattern corresponding to a shouting voice or a threatening voice, which are often heard when the user is being harmed by another party. That is, for example, the predetermined pattern corresponds to a voice at a predetermined volume or louder. The predetermined pattern may be a voice pattern corresponding to a threatening voice.

The controller 13 also acquires, as the predetermined data, data indicating temporal variations in the acceleration acquired by the acceleration sensor 11 and stores the predetermined data in the data memory 12C. The controller 13 controls the sound output on the basis of the temporal variations of the acceleration stored in the memory 12. For example, when the temporal variations in the acceleration do not correspond to a predetermined pattern, the controller performs the first operation. When the temporal variations of the acceleration correspond to the predetermined pattern, the controller performs the second operation. The predetermined pattern for the temporal variations in the acceleration may correspond to a pattern indicating the temporal variations in the acceleration detected by the acceleration sensor 11 in the cases where, for example, the user of the smartphone 1 is suddenly pulled or pushed away.

Also, surrounding data indicating the presence or absence of a person near the smartphone 1 may be used as the predetermined data. In this case, the communication interface 6 may acquire the surrounding data from an external server or directly from a nearby communication apparatus. The controller 13 controls the sound output on the basis of the surrounding data. For example, when the surrounding data acquired in a predetermined time period before the predetermined operation is detected by the operation detector 4 indicates the presence of a nearby person, the controller 13 determines that the surrounding data corresponds to the predetermined pattern and performs the first operation. When the surrounding data acquired in the predetermined time period before the predetermined operation is detected by the operation detector 4 indicates the absence of a nearby person, the controller 13 determines that the surrounding data does not correspond to the predetermined pattern and performs the second operation. Preferably, the predetermined time period is within a time period in which there should be no discrepancy between a point when the predetermined operation is detected and a point when the surrounding data is acquired.

The controller 13 may store, as the predetermined data, users biometric information acquired by the sensor in the data memory 12C. In this case, the sensor may be any sensor built into the smartphone 1 or an external sensor connected to the smartphone 1. The biometric information indicates variations of user's breathing, pulse, sweating, tears, tremor, and so on. In this case, the controller 13 may selectively perform the first operation or the second operation on the basis of the biometric information stored in the data memory 12C.

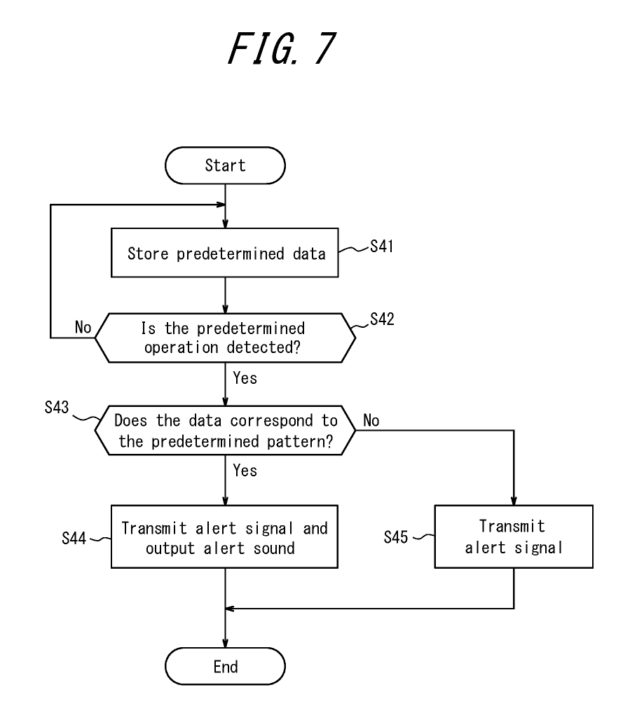

Here, operation of the smartphone 1 according to the fourth embodiment will be described with reference to FIG. 7. The controller 13 starts the operation illustrated in FIG. 7 when the smartphone 1 is activated.

First, a case in which the voice or the temporal variation of the acceleration is used as the predetermined data will be described.

First, the controller 13 stores the predetermined data acquired by the smartphone 1 in the data memory 12C (step S41).

After storing the predetermined data at step S41, the controller 13 determines whether the predetermined operation is detected by the operation detector 4 (step S42).

When the predetermined operation is detected at step S42, the controller 13 determines whether the predetermined data stored at step S41 corresponds to the predetermined pattern, e.g., whether the data acquired by the sound output interface 7 corresponds to the voice pattern for a threatening voice (step S43). That is, at step S43 it is determined whether the predetermined data stored in the data memory 12C before the detection of the predetermined operation at step S42 corresponds to the predetermined pattern. When the predetermined operation is not detected at step S42, the controller 13 returns to step S41 and again determines whether the predetermined operation is detected by the operation detector 4. That is, the controller 13 keeps the predetermined data acquired by the smartphone 1 in the data memory 12C until the predetermined operation is detected by the operation detector 4.

At this point, the controller 13 may determine whether the data acquired by the acceleration sensor 11 corresponds to the pattern for temporal variations in the acceleration in the cases where the user is suddenly pulled or pushed away.

When the predetermined data corresponds to the predetermined pattern at step S43, e.g., when the data acquired by the sound output interface 7 corresponds to the voice pattern for a threatening voice, the controller 13 causes the communication interface 6 to transmit the predetermined alert signal and the sound output interface 7 to output the predetermined alert sound (step S44).

When the predetermined data does not correspond to the predetermined pattern at step S43, the controller 13 causes the communication interface 6 to transmit the predetermined alert signal (step S45).

Next, a case in which the surrounding data indicating the presence or absence of a nearby person is used as the predetermined data will be described.

As illustrated in FIG. 7, the controller 13 stores, as the predetermined data, the surrounding data received by the communication interface 6 in the data memory 12C (step S41).

After storing the surrounding data at step S41, the controller 13 determines whether the predetermined operation is detected by the operation detector 4 (step S42).

When the predetermined operation is detected at step S42, the controller 13 determines whether the surrounding data stored at step S41 corresponds to the predetermined pattern, i.e., whether the surrounding data indicates the existence of a nearby person (step S43). When the predetermined operation is not detected at step S42, the controller 13 returns to step S41 and again stores the surrounding data received by the communication interface 6 in the data memory 12C.

When there is a nearby person at step S43, the controller 13 causes the communication interface 6 to transmit the predetermined alert signal and causes the sound output interface 7 to output the predetermined alert sound (step S44).

When there is no nearby person at step S43, the controller 13 causes the communication interface 6 to transmit the predetermined alert signal (step S45).

According to the fourth embodiment, as described above, when the operation is detected by the operation detector 4, the controller 13 selectively performs the first operation or the second operation on the basis of the predetermined data acquired by the smartphone 1. The predetermined data acquired by the smartphone 1 enables a situation of the user of the smartphone 1 to be inferred. For example, when the user is threatened or pushed away by a party, the alert sound is not output for the purpose of avoiding upsetting the party, thus avoiding greater danger for the user. On the other hand, when the user is not threatened or thrust away, it is likely that the user is not being harmed by a party. In this case, it is effective to output the alert sound to seek help from a nearby third party. Thus, the controller 13 controls to selectively output the sound depending on the user's situation. This configuration contributes to the safety of the user.

### Fifth Embodiment

Next, a fifth embodiment of the present disclosure will be described with reference to the accompanying drawings. According to the first to fourth embodiments, the first or the second operation is selectively performed when the predetermined operation is detected. According to the present embodiment, on the other hand, a predetermined operation to start the first operation and a predetermined operation to start the second operation are distinguished from each other. In this way, the user may perform different operations to immediately start the first operation or the second operation as desired.

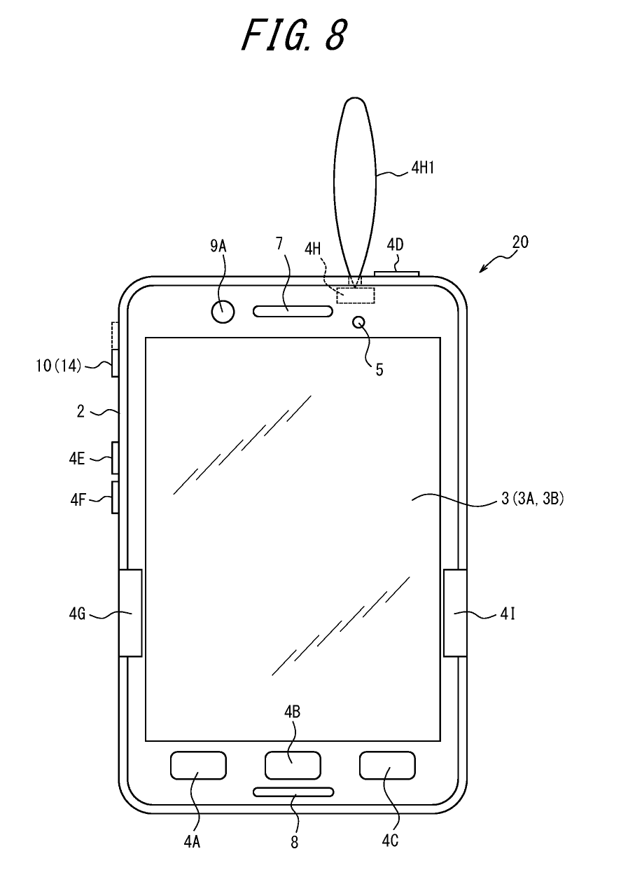

As illustrated in FIG. 8, a smartphone 20 serving as a mobile electronic device 20 according to the fifth embodiment includes the housing 2, the touchscreen display 3, the operation detector 4, the proximity sensor 5, the sound output interface 7, the microphone 8, and the camera 9, as with the smartphone 1 according to the first embodiment. In the smartphone 20 according to the fifth embodiment, the operation detector 4 further includes an operation detector 4I in addition to the operation detectors 4A to 4H. According to the present embodiment, therefore, the smartphone 20 includes a plurality of operation detectors 4.

The operation detector 4G and the operation detector 4I are arranged in positions that allow simultaneous operation thereof by one hand of the user. As illustrated in FIG. 8, for example, the operation detector 4G is arranged on a right side of the housing 2, while the operation detector 4G is arranged on a left side of the housing 2. In response to the push-operation performed by the user, the operation detector 4G is displaced toward the operation detector 4I and the operation detector 4I is displaced toward the operation detector 4G In this example, the operation detector 4G and the operation detector 4I are arranged in a manner enabling a simultaneous operation thereof. However, their arrangements are not limited thereto. At least two of the operation detectors 4A to 4I need to be arranged in a manner enabling a simultaneous operation thereof.

When determining that the operation detected by the operation detector 4 corresponds to a first predetermined action, the controller 13 performs the first operation. When determining that the operation detected by the operation detector 4 corresponds to a second predetermined action, the controller 13 performs the second operation.

In particular, when the controller 13 determines that the operation detected by the operation detector 4 corresponds to the first predetermined action, the controller 13 causes the communication interface 6 to transmit the predetermined alert signal and causes the sound output interface 7 to output the predetermined alert sound. On the other hand, when the controller 13 determines that the operation detected by the operation detector 4 corresponds to the second predetermined action, the controller 13 causes the communication interface 6 to transmit the predetermined alert signal but does not cause the sound output interface 7 to output the predetermined alert sound. For example, the first predetermined action is the long-press (i.e. a press operation lasting for at least 2 seconds), and the second predetermined action is a predetermined number of successive presses (e.g., an operation comprising three consecutive presses each lasting for less than 2 seconds). However, the first and second predetermined actions are not limited thereto.

The controller 13 may determine the first predetermined action and the second predetermined action as two different operations simultaneously detected by at least two of the operation detectors 4A to 4I. In this case, for example, the controller 13 detects the operation to the operation detector 4G and the operation to the operation detector 4I. When simultaneously detecting the operation to the operation detector 4G and the operation to the operation detector 4I, the controller 13 selectively performs the first operation or the second operation.

In particular, when the controller 13 determines that the operation to the operation detector 4G and the operation to the operation detector 4I are concurrent and correspond to the first predetermined action, the controller 13 performs the first operation. When the controller 13 determines that the operation to the operation detector 4G and the operation to the operation detector 4I are concurrent and correspond to the second predetermined action, the controller 13 performs the second operation.

In the second operation, the controller 13 may control such that the sound output interface 7 gradually increases the volume or outputs the mosquito sound on the basis of a pre-set, similarly to the first embodiment. The controller 13 may cause the touchscreen display 3 to display the confirmation screen on the basis of the pre-set. In this case, the controller 13 performs control such that the alert sound is output after contact made to the display region of the “Output Sound” option is detected.

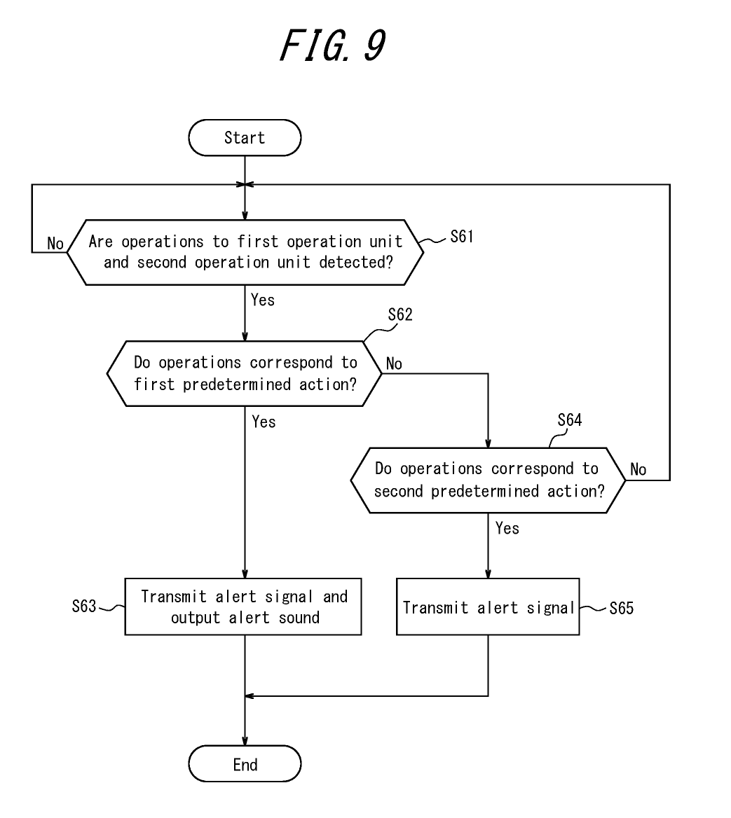

Here, operation of the smartphone 1 according to the fifth embodiment will be described with reference to FIG. 9. The controller 13 starts this operation when the smartphone 1 is activated.

First, the controller 13 determines whether the operations are respectively detected by the operation detector 4G and the operation detector 4I (step S61).

When the operations are detected at step S61, the controller 13 determines whether the operations correspond to the first predetermined action (step S62).

When the operations correspond to the first predetermined action at step S62, the controller 13 causes the communication interface 6 to transmit the predetermined alert signal and the sound output interface 7 to output the predetermined alert sound (step S63).

When the detected operations do not correspond to the first predetermined action at step S62, the controller 13 determines whether the operation to the operation detector 4G and the operation to the operation detector 4I correspond to the second predetermined action (step S64).

When the operation to the operation detector 4G and the operation to the operation detector 4I correspond to the second predetermined action at step S64, the controller 13 causes the communication interface 6 to transmit the predetermined alert signal (step S65). When the operations do not correspond to the second predetermined action at step S64, the controller 13 returns to step S61 and again determines whether the operations are detected by the operation detector 4G and the operation detector 4I. Note that, when the operations correspond to the second predetermined action at step S64, the controller 13 may perform the procedures from step S4 to step S12 according to the first embodiment, on the basis of the pre-set.

According to the fifth embodiment, as described above, the controller 13 performs the first operation when determining that the operations detected by a plurality of operation detectors 4 correspond to the first predetermined action, or performs the second operation when determining that the operations detected by the plurality of operation detectors 4 correspond to the second predetermined action. This configuration enables the user to set the controller 13 to selectively output the sound according to the users situation. Thus, when, for example, there is no risk of upsetting a person who is trying to harm the user by outputting the alert sound from the smartphone 1, the user may perform the first predetermined action to the smartphone 1 to seek help from a nearby person. On the other hand, when there is a risk of upsetting the person, the user may perform the second predetermined action to prevent a unfavorable situation. That is, the smartphone 1 may appropriately operate according to situations and thus contribute to the safety of the user.

The above embodiments are typical examples, and it should be apparent to those who are skilled in the art that various changes and substitutions may be implemented within the spirit and scope of the present disclosure. Accordingly, the present disclosure should not be construed as limited to the above embodiments but may be altered or changed in various manners without departing from the scope of the claims. For example, a plurality of constituent blocks in the above embodiments may be combined together, or one constituent block may be separated.

1. A mobile electronic device comprising:
a communication interface configured to transmit a signal;
a sound output interface configured to output a sound;
one or more operation detectors configured to detect a user operation; and
a controller configured to selectively perform a first operation or a second operation when a predetermined operation is detected by the one or more operation detectors,
wherein:
in the first operation, the controller causes the sound output interface to output a predetermined alert sound and causes the communication interface to transmit a predetermined alert signal, and
in the second operation, the controller does not cause the sound output interface to output the predetermined alert sound and causes the communication interface to transmit the predetermined alert signal.

2. The mobile electronic device according to claim 1,
wherein the controller enables a setting to select which of the first operation and the second operation is performed.

3. The mobile electronic device according to claim 1,
comprising an operation switch configured to enable selection between the first operation and the second operation,
wherein the controller selectively performs the first operation or the second operation in accordance with the selection according to the operation switch.

4. The mobile electronic device according to claim 3,
comprising a sound output switch configured to enable or disable sound output,
wherein the controller selectively controls sound output from the sound output interface on the basis of a selection according to the sound output switch, and
the sound output switch also serves as the operation switch.

5. The mobile electronic device according to claim 4,
wherein the controller
performs the first operation when the sound output switch is set to enable sound output, and
performs the second operation when the sound output switch is set to disable sound output.

6. The mobile electronic device according to claim 1,
wherein the controller, in the second operation, causes the sound output interface to output a sound different from the predetermined alert sound.

7. The mobile electronic device according to claim 6,
wherein the controller causes the sound output interface to output a mosquito sound.

8. The mobile electronic device according to claim 6,
wherein the controller causes the sound output interface to output a sound which gradually increases in volume.

9. The mobile electronic device according to claim 1,
wherein, after causing the communication interface to transmit the predetermined alert signal in the second operation, the controller outputs the predetermined alert sound on the basis of a user operation detected by the one or more operation detectors.

10. The mobile electronic device according to claim 1,
comprising a sensor configured to detect predetermined data indicating a situation of the mobile electronic device,
wherein, when the user operation is detected by the one or more operation detectors, the controller selectively performs the first operation or the second operation on the basis of the data detected by the sensor.

11. The mobile electronic device according to claim 1,
comprising a memory configured to store predetermined data acquired by the mobile electronic device,
wherein, when the user operation is detected by the one or more operation detectors, the controller selectively performs the first operation or the second operation on the basis of the data stored in the memory.

12. The mobile electronic device according to claim 1,
wherein the controller
performs the first operation upon determining that the operation detected by the one or more operation detectors corresponds to a first predetermined action, and
performs the second operation upon determining that the operation detected by the one or more operation detectors corresponds to a second predetermined action.

13. The mobile electronic device according to claim 12,
wherein
the one or more operation detectors comprises a plurality of operation detectors, and
the controller determines the first predetermined action and the second predetermined action as two different operations simultaneously detected by at least two of the plurality of operation detectors.
